(19) United States
(12) Patent Application Publication
(10) Pub. No.: US 2006/0025119 A1
(43) Pub. Date: Feb. 2, 2006

(54) Converter for mobile telecommunication networks for the generation of standard formats

(76) Inventors: Klemens Guida, Alpen (DE); Marco Iannacone, Segrate (IT)

Correspondence Address: SILBER & FRIDMAN, 1037 ROUTE 46 EAST, SUITE 207, CLIFTON, NJ, 07013, US

(21) Appl. No.: 11/117,742

(22) Filed: Apr. 22, 2005

Related U.S. Application Data
(63) Continuation of application No. PCT/EP03/11664, filed on Oct. 21, 2003.

(30) Foreign Application Priority Data
Oct. 23, 2002 (DE) 102 49 527.0

(51) Int. Cl. H04L 29/08

(52) U.S. Cl. 455/414.4; 455/414.1

(57) ABSTRACT

The invention relates to a mobile telecommunication network device, in particular according to the GSM- or UMTS-standards, with a central computer- and switching unit, wherein the computer- and switching unit switches in particular speech-, text-, picture- or binary data between two communication parters to the mobile telecommunication network device by means of the mobile telecommunication network. Therefore, the mobile telecommunication network device is provided with suitable receiver and transmitter units. The mobile telecommunication network device furthermore consists of mobile stations, wherein the mobile stations comprise means for generating and/or transmitting text data and/or picture data. These text data are converted in such a way, that they can be processed by any further mobile station. Furthermore the invention relates to a corresponding conversion method in a mobile telecommunication network device.

### FIELD OF THE INVENTION

The invention relates to a mobile telecommunication network device, in particular according to the GSM- or UMTS-standards, comprising:
(a) a central computer and switching unit, wherein the computer and switching unit switches in particular speech, text, picture, or binary data between two communication partners to the mobile telecommunication network device by means of the mobile telecommunication network,
(b) receiver and transmitter units,
(c) mobile stations, wherein the mobile stations comprise means for generating and/or transmitting text data and/or picture data.

Furthermore, the invention relates to a conversion method in a mobile telecommunication network device with a central computer and switching unit, in particular according to the GSM or UMTS standards, wherein the computer and switching unit switches in particular speech, text, picture or binary data between two communication partners by means of the mobile telecommunication network.

### BACKGROUND OF THE INVENTION

Mobile stations, in particular according to the GSM or UMTS-standards, are well known. They are described in numerous publications, for example in “GSM Global System for Mobile Communication”, 2. Edition, Eberspächer/Vögel, published by Teubner Stuttgart-Leipzig. The mobile telecommunication network devices essentially consist of receiver and transmitter masts, which are mounted, for example, on houses or churches to area-wide provide entire regions with a connection to the mobile telecommunication network.

In these mobile telecommunication networks people can communicate with mobile stations, such as, for example, mobile phones. The administration and the switching between the communication partners and the mobile stations, respectively, are normally carried out in a central computer and switching unit. All speech, text or other binary data exchanged between the communication partners pass such central computer and switching unit.

Nowadays texts, pictures and other data are exchanged between communication partners very often. Text, for example, is sent by SMS or email. As the mobile stations and mobile telecommunication network devices are increasingly becoming effective, the texts may, accordingly, also become larger.

Apart from the pure characters, which are normally provided in the ASCII format, a text file consists of numerous control characters indicating, for example, whether a text shall be printed bold or at which point a paragraph ends, where a text is positioned and the like. Such control characters ultimately form the format of a text. A device not from the manufacturer, which cannot process this text format, will completely misinterpret the control characters.

When texts are transmitted, it is a problem that practically every manufacturer of mobile stations and conventional telecommunication network stations uses their own text format. Thereby it is often impossible to process texts which have been generated and transmitted by the mobile station of one manufacturer with the mobile station of another manufacturer. The same obviously applies for picture formats or, for example, digital film formats. This is the case for all formats which are processed by another communication partner.

Apart from an agreement between the manufacturers, the only possibility to process such text formats is that the mobile stations are provided with their own converter to process the text and picture formats of different manufacturers.

### SUMMARY OF THE INVENTION

It is an object of the invention to provide a mobile telecommunication network device and a method for a mobile telecommunication network, wherein all mobile stations, regardless of which manufacturer has produced them, can process, if possible, all transmitted formats.

According to the invention this object is achieved with a mobile telecommunication network device of the above mentioned kind in that:
(d) conversion means are provided in the central computer and switching unit which convert the texts which have to be switched into a standard format which is processable by any further mobile station.

Furthermore the object is achieved by a conversion method in a mobile telecommunication network device of the above mentioned kind wherein a central conversion unit converts the text data in a standard format which is processable by any further mobile station.

The invention is based on the principle, that different text formats are centrally administered as far as the electronic data processing is concerned, that they are converted into a standard format and then switched to the mobile station of the corresponding communication partner. For this purpose it is necessary that the conversion unit is provided with practically all current text formats to convert the respective text control characters.

It is an advantageous modification of the invention, if the conversion means are provided in the central computer- and switching unit, which converts the pictures, which have to be transmitted, into a standard format which can be processed by every other mobile station. By this measure the different picture formats can be transmitted in a standard format, also.

In a further advantageous modification conversion means are provided in the central computer- and switching unit, which convert the binary data formats which have to be switched into an allocated standard format corresponding to the data format, which is processable for every other mobile station. As there are further binary formats additional to text- and picture formats, thereby digital films, for example, are converted to a standard format, also.

As the conversion unit works its way through each text file, there is, according to an advantageous modification, the possibility to translate the text into a different language. For this purpose suitable conversion means are provided in the central computer- and switching unit, which translate the texts which have to be switched from one language into another selected language. Preferably the texts are translated into the respective language of a country.

In a preferred embodiment of the method according to the invention pictures which have to be switched are converted by the central conversion means into a standard format which is processable by every other mobile station.

In a preferred modification of the method according to the invention the binary data to be switched are converted by the central conversion unit into a standard format which is processable by every other mobile station.

A preferred aspect of the invention consists in that the texts which have to be switched are translated from one language into another selected language by the conversion unit. Preferably the respective language of the country is suitable.

Further advantages result from the subject matter of the subclaims.

### BRIEF DESCRIPTION OF THE DRAWING

FIG. 1 shows a principle sketch of the functionality of a mobile telecommunication network device according to the invention.

### DESCRIPTION OF PREFERRED EMBODIMENT

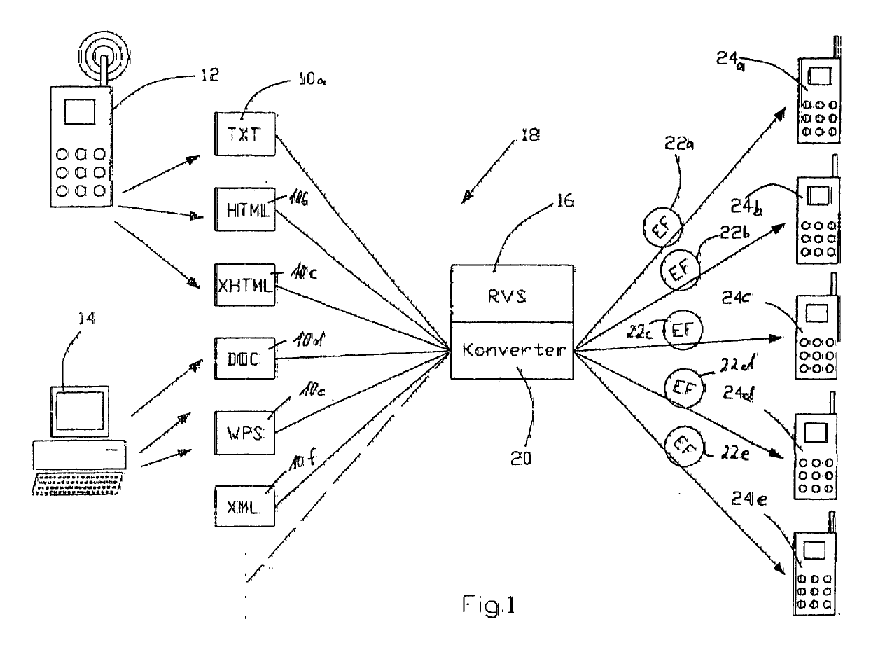

In view of FIG. 1 the mode of operation of the invention shall be explained. In FIG. 1 numeral 10 designates the different text formats. These text formats 10 are transmitted to a central computer- and switching exchange 16 of a mobile telecommunication network device 18 either by mobile stations 12 or by conventional telecommunication network stations. A mobile phone is symbolically shown in this drawing as a mobile station 12. Correspondingly, a computer is symbolically shown as a conventional telecommunication network station. The transmission of the data in different data formats 10a-10f is effected in the normal way which is known to the person skilled in the art.

A converter 20 knowing all common data formats converts the different data formats 10a-10f arriving therein into standard formats 22a-22e. The converted standard text formats 22 are then switched to the mobile stations 24. These standard text formats 22 are in such kind, that they can be processed by any mobile station 24.

This conversion obviously works not only for texts but also for pictures, films or any other binary data which have to be processed by another communication partner.

1. Mobile telecommunication network device in particular according to the GSM- or UMTS-standards, comprising
(a) a central computer- and switching unit, wherein the computer- and switching unit switches in particular speech-, text-, picture- or binary data between two communication partners to the mobile telecommunication network device by means of the mobile telecommunication network,
(b) receiver and transmitter units,
(c) mobile stations, wherein the mobile stations comprise means for generating and/or transmitting (weiterleiten) text data and/or picture data, and
(d) conversion means are provided in the central computer- and switching unit which convert the data which have to be switched into a standard format which is processable by any further mobile station.

2. Mobile telecommunication network device according to claim 1, wherein conversion means are provided in the central computer- and switching unit, which convert the texts and/or pictures, which have to be transmitted, into a standard format which is processable by every other mobile station.

3. Mobile telecommunication network device according to claim 1, wherein conversion means are provided in the central computer- and switching unit, which convert the binary data formats which have to be switched into an allocated standard format corresponding to the data format, which is processable for every other mobile station.

4. Mobile telecommunication network device according to claim 1, wherein conversion means are provided in the central computer- and switching unit which translate the texts which have to be switched from one language into another selected language.

5. Mobile telecommunication network device according to claim 4, wherein conversion means are provided in the central computer- and switching unit, which translates texts into the respective language of a country.

6. Conversion method in a mobile telecommunication network device with a central computer- and switching unit, in particular according to the GSM- or UMTS standards, wherein the computer- and switching unit switches in particular speech-, text-, picture- or binary data between two communication partners by means of the mobile telecommunication network, comprising the step of converting by a central conversion unit the data into a standard format which is processable by any further mobile station.

7. Conversion method in a mobile telecommunication network device according to claim 6, wherein the texts and/or pictures which have to be switched are converted by the central conversion means into a standard format which is processable by every other mobile station.

8. Conversion method in a mobile telecommunication network device according to claim 6, wherein the binary data to be switched are converted by the central conversion unit into a standard format which is processable by every other mobile station.

9. Conversion method in a mobile telecommunication network device according to claim 6, wherein the texts which have to be switched are translated from one language into another selected language by the conversion unit.

10. Conversion method in a mobile telecommunication network device according to claim 6, wherein the texts in one language which have to be switched are translated into the respective other language.
